(19) United States
(12) Patent Application Publication
(10) Pub. No.: US 2026/0220734 A1
(43) Pub. Date: Jul. 30, 2026

(54) DIGITAL WATERMARKING METHODS AND SYSTEMS

(71) Applicant: Nanyang Technological University, Singapore (SG)

(72) Inventors: Wai Kin Adams KONG, Singapore (SG); Yew Lee TAN, Singapore (SG); Shifeng XU, Singapore (SG)

(21) Appl. No.: 19/458,331

(22) Filed: Jan. 23, 2026

(30) Foreign Application Priority Data
Jan. 24, 2025 (SG) 10202500221S

(51) Int. Cl. G06T 1/00

(52) U.S. Cl. CPC G06T 1/0021

(57) ABSTRACT

A digital watermarking method comprises: generating a base watermark comprising a two-dimensional pixel array partitioned into image patches from a watermark data set by embedding the watermark data set into the image patches of the base watermark according to patch positional indices; and embedding the base watermark into the digital file by circular padding.

### CROSS-REFERENCE TO RELATED APPLICATIONS

The present application claims priority to Singapore Application No. 10202500221S filed with the Singapore Patent Office on Jan. 24, 2025, which is incorporated herein by reference in its entirety for all purposes.

### TECHNICAL FIELD

The present disclosure relates to digital watermarking.

### BACKGROUND

Digital watermarking generally refers to data that is embedded into document while remaining visually imperceptible. Should information from document be leaked to unintended or unauthorized party, the embedded invisible watermark may help with tracing the source of leakage for damage control or preventing similar leakage from happening.

FIGS. 1A-1G illustrate seven leakage scenarios where Alice and Bob are authorized to view the document while Carol is not.

As show in FIG. 1A, in Leakage 1 Alice sends a confidential document to Bob. Bob (regardless of intention) sends the file to an unauthorized party, Carol.

As shown in FIG. 1B, in Leakage 2 Alice sends a confidential document to Bob. Bob takes a screenshot of the document and sends it to Carol.

As shown in FIG. 1C in Leakage 3 Alice sends a confidential document to Bob. Bob takes a photo of the document with his mobile phone and sends it to Carol.

As shown in FIG. 1D in Leakage 4 Alice shares her screen during an online meeting in which the document is shown. Bob takes a screenshot of it and sends it to Carol.

As shown in FIG. 1E in Leakage 5 Alice shares her screen during an online meeting in which the document is shown. Bob takes a photo of the document with his mobile phone and sends it to Carol.

As shown in FIG. 1F in Leakage 6 Alice takes a screenshot of the document and sends it to Bob. Bob then forwards this image to Carol.

As shown in FIG. 1G in Leakage 7 Alice takes a screenshot of the document and sends it to Bob. Bob takes a photo of it and sends it to Carol.

Watermarking can be applied to the scenarios either actively or passively. Active watermarking refers to the embedding of watermark into document at document creator's end with the creator's deliberate intent. In the scenarios, if active watermarking is to be applied, it will be at Alice's end.

Whereas in passive watermarking, watermark is embedded at authorized document receiver's end. In this case, passive watermark refers to watermark applied at Bob's end (by the organization assuming that Bob is using corporate device). It is to be noted that some methods can be applied to different leakage scenarios depending on whether it is active or passive watermarking.

Generally, the methods of embedding invisible watermark into electronic documents can be categorized into two broad groups namely text-dependent and text-independent. Text-dependent methods embed invisible watermark into electronic document through the modification of text content or text stream like adding invisible American Standard Code for Information Interchange (ASCII) characters, replacing words with synonyms, or modifying line spacing. However, they require the presence of text, and their effectiveness is generally dependent on the amount of text. Correspondingly, text-independent methods embed invisible watermark by modifying other aspects of the document like the file stream], or converting document into image and embed watermark into the image.

Examples of text dependent invisible watermarking are described in the following documents:
[1] Lee, I. S., & Tsai, W. H. (2010). A new approach to covert communication via PDF files. Signal processing, 90 (2), 557-565.
[2] Atallah, M. J., McDonough, C. J., Raskin, V., & Nirenburg, S. (2001 February). Natural language processing for information assurance and security: an overview and implementations. In Proceedings of the 2000 workshop on New security paradigms (pp. 51-65).
[3] Tyagi, S., Dwivedi, R. K., & Saxena, A. K. (2019). A High Capacity PDF Text Steganography Technique Based on Hashing Using Quadratic Probing. International Journal of Intelligent Engineering & Systems, 12 (3).
[4] Ekodeck, S. G. R., & Ndoundam, R. (2016). PDF steganography based on Chinese Remainder Theorem. Journal of information security and applications, 29, 1-15.
[5] Topkara, U., Topkara, M., & Atallah, M. J. (2006 September). The hiding virtues of ambiguity: quantifiably resilient watermarking of natural language text through synonym substitutions. In Proceedings of the 8th workshop on Multimedia and security (pp. 164-174).
[6] Atallah, M. J., Raskin, V., Crogan, M., Hempelmann, C., Kerschbaum, F., Mohamed, D., & Naik, S. (2001). Natural language watermarking: Design, analysis, and a proof-of-concept implementation. In Information Hiding: 4th International Workshop, I H 2001 Pittsburgh, PA, USA, Apr. 25-27, 2001 Proceedings 4 (pp. 185-200). Springer Berlin Heidelberg.
[7] Atallah, M. J., Raskin, V., Hempelmann, C. F., Karahan, M., Sion, R., Topkara, U., & Triezenberg, K. E. (2002 October). Natural language watermarking and tamperproofing. In International workshop on information hiding (pp. 196-212). Berlin, Heidelberg: Springer Berlin Heidelberg.
[8] Meral, H. M., Sankur, B., Özsoy, A. S., Güngör, T., & Sevinç, E. (2009). Natural language watermarking via morphosyntactic alterations. Computer Speech & Language, 23 (1), 107-125.
[9] Murphy, B., & Vogel, C. (2007 February). The syntax of concealment: reliable methods for plain text information hiding. In Security, steganography, and watermarking of multimedia contents IX (Vol. 6505, pp. 351-362). SPIE.
[10] Abdelnabi, S., & Fritz, M. (2021 May). Adversarial watermarking transformer: Towards tracing text provenance with data hiding. In 2021 IEEE Symposium on Security and Privacy (SP) (pp. 121-140). IEEE.
[11] Yang, X., Zhang, J., Chen, K., Zhang, W., Ma, Z., Wang, F., & Yu, N. (2022 June). Tracing text provenance via context-aware lexical substitution. In Proceedings of the AAAI Conference on Artificial Intelligence (Vol. 36, No. 10, pp. 11613-11621).
[12] Jiang, Z., Wang, H., & Han, S. (2024). A robust PDF watermarking scheme with versatility and compatibility. Multimedia Tools and Applications, 1-27.
[13] Qiang, J., Zhu, S., Li, Y., Zhu, Y., Yuan, Y., & Wu, X. (2023). Natural language watermarking via paraphraser-based lexical substitution. Artificial Intelligence, 317, 103859.
[14] Brassil, J. T., Low, S., & Maxemchuk, N. F. (1999). Copyright protection for the electronic distribution of text documents. Proceedings of the IEEE, 87 (7), 1181-1196.
[15] Huang, D., & Yan, H. (2001). Interword distance changes represented by sine waves for watermarking text images. IEEE Transactions on Circuits and Systems for Video Technology, 11 (12), 1237-1245.
[16] Kim, Y. W., Moon, K. A., & Oh, I. S. (2003 August). A text watermarking algorithm based on word classification and inter-word space statistics. In ICDAR (pp. 775-779).
[17] Kong, T., Zhou, H., Qu, H., Chen, J., Wang, C., & Li, J. (2024 August). Enhancing data leakage tracing: a novel digital watermarking method for document files. In Fifth International Conference on Computer Communication and Network Security (CCNS 2024) (Vol. 13228, pp. 444-451). SPIE. 15

### Examples of Text Independent Invisible Watermarking are Described in the Following Documents

[18] Al Shaikhli, I. F., Zeki, A. M., Makarim, R. H., & Pathan, A. S. K. (2012 March). Protection of integrity and ownership of PDF documents using invisible signature. In 2012 UKSim 14^{th} International Conference on Computer Modelling and Simulation (pp. 533-537). IEEE.
[19] Zhao, W., Guan, H., Huang, Y., & Zhang, S. (2020 October). Research on double watermarking algorithm based on PDF document structure. In 2020 International Conference on Culture-oriented Science & Technology (ICCST) (pp. 298-303). IEEE.3
[20] Jiang, Z., Wang, H., & Han, S. (2024). A robust PDF watermarking scheme with versatility and compatibility. Multimedia Tools and Applications, 1-27.
[21] Kim, Y. W., & Oh, I. S. (2004). Watermarking text document images using edge direction histograms. Pattern Recognition Letters, 25 (11), 1243-1251.
[22] Alakk, W., Al-Ahmad, H., & Kunhu, A. (2014 July). A new watermarking algorithm for scanned grey PDF files using DWT and hash function. In 2014 9th International Symposium on Communication Systems, Networks & Digital Sign (CSNDSP) (pp. 690-693). IEEE.
[23] Mahmoud, A., Al Maharmeh, H., & Al-Ahmad, H. (2015 May). A new watermarking algorithm for scanned colored PDF files using DWT and hash function. In 2015 International Conference on Information and Communication Technology Research (ICTRC) (pp. 140-143). IEEE.
[24] Ge, S., Xia, Z., Fei, J., Tong, Y., Weng, J., & Li, M. (2023). A robust document image watermarking scheme using deep neural network. Multimedia Tools and Applications, 82 (25), 38589-38612.
[25] Ge, S., Fei, J., Xia, Z., Tong, Y., Weng, J., & Liu, J. (2023). A screen-shooting resilient document image watermarking scheme using deep neural network. IET Image Processing, 17 (2), 323-336.

Text-dependent methods generally require the presence of text in document. Hence, the effectiveness of such methods may suffer if the document has little text or contains forms and tables. Image-based methods are more diverse in terms of the type of document they can apply to. However, they are not applicable in most of the scenarios because they require the document to be first converted into image.

### SUMMARY

According to a first aspect of the present disclosure a method of digitally watermarking a digital file is provided. The method comprises: generating a base watermark comprising a two-dimensional pixel array partitioned into image patches from a watermark data set by embedding the watermark data set into the image patches of the base watermark according to patch positional indices; and embedding the base watermark into the digital file by circular padding.

In view that current methods are not practical in many of the leakage scenarios, the present disclosure provides a deep learning model with three different text-independent, content-agnostic methods of embedding watermark into electronic document. These methods are applicable to various scenarios as described in more detail below. A minimum crop resolution strategy is also proposed and integrated into the design of the model's architecture. Minimum crop resolution (Hₘᵢₙ, Wₘᵢₙ) is the smallest crop size for which any crop of a circularly padded watermark contains a sub-crop that is a phase-shifted instance of the base watermark, enabling shift-invariant extraction. Additionally, text noise is also introduced so that the watermark is robust to text variations.

In an embodiment, the digital file is a screenshot image and embedding the base watermark into the digital file by circular padding comprises applying the base watermark as an image overlay.

In an embodiment, the digital file is a screen display and embedding the base watermark into the digital file by circular padding comprises applying the base watermark as an image overlay.

In an embodiment, the digital file is an electronic document and embedding the base watermark into the digital file by circular padding comprises applying the base watermark as a document underlay.

In an embodiment the method further comprises applying text noise to the base watermark.

In an embodiment, a size of the base watermark is selected to provide a minimum crop resolution.

In an embodiment, embedding the watermark data set into image patches of the base watermark according to patch positional indices comprises applying a multi-head attention layer.

In an embodiment, embedding the base watermark into the digital file by circular padding comprising using a patch positional indices.

In an embodiment, embedding the base watermark into the digital file by circular padding comprises using circular padding and cropping.

According to a second aspect of the present disclosure a non-transitory computer readable medium carrying computer executable instructions which when executed on a processor cause the processor to carry out a method configured to carry out a method as set out above is provided.

According to a third aspect of the present disclosure, a digital watermarking system is provided. The digital watermarking system comprises: a processor and a data storage device storing computer program instructions operable to cause the processor to: generate a base watermark comprising a two-dimensional pixel array partitioned into image patches from a watermark data set by embedding the watermark data set into the image patches of the base watermark according to patch positional indices; and embed the base watermark into the digital file by circular padding.

In an embodiment, the digital file is a screenshot image and the data storage device further stores computer program instructions operable to cause the processor to embed the base watermark into the digital file by circular padding by applying the base watermark as an image overlay.

In an embodiment, the digital file is a screen display and the data storage device further stores computer program instructions operable to cause the processor to embed the base watermark into the digital file by circular padding by applying the base watermark as an image overlay.

In an embodiment, the digital file is an electronic document and the data storage device further stores computer program instructions operable to cause the processor to embed the base watermark into the digital file by circular padding by applying the base watermark as a document underlay.

In an embodiment, the data storage device further stores computer program instructions operable to cause the processor to apply text noise to the base watermark.

In an embodiment, a size of the base watermark is selected to provide a minimum crop resolution.

In an embodiment, the data storage device further stores computer program instructions operable to cause the processor to embed the watermark data set into image patches of the base watermark according to patch positional indices by applying a multi-head attention layer.

In an embodiment, the data storage device further stores computer program instructions operable to cause the processor to embed the base watermark into the digital file by circular padding using a patch positional indices.

In an embodiment, the data storage device further stores computer program instructions operable to cause the processor to embed the base watermark into the digital file by circular padding using circular padding and cropping.

In an embodiment, the data storage device further stores computer program instructions operable to cause the processor to extract a digital watermark from a digital file.

### BRIEF DESCRIPTION OF THE DRAWINGS

In the following, embodiments of the present invention will be described as non-limiting examples with reference to the accompanying drawings in which:

FIG. 1A to FIG. 1G illustrate scenarios in which a document is leaked;

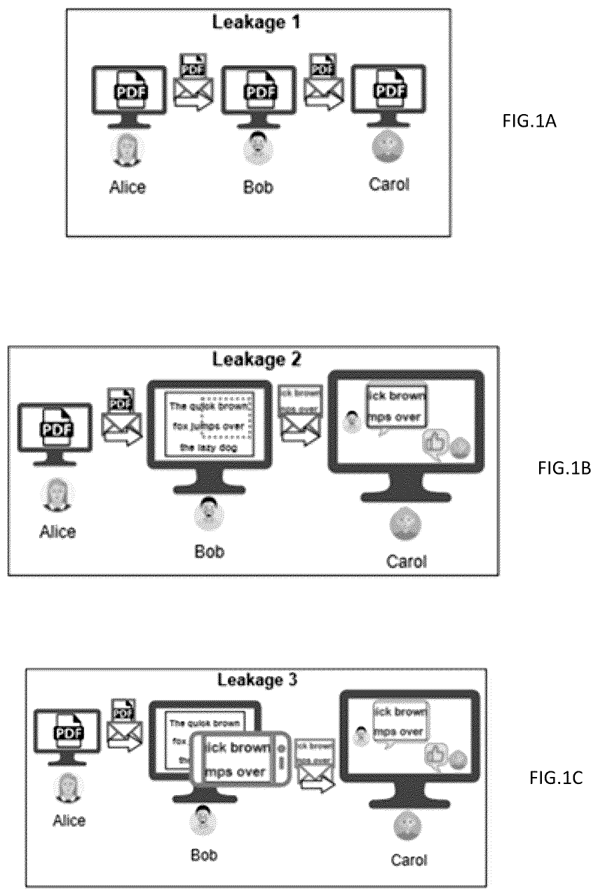

FIG. 2 is a block diagram showing a digital watermarking system according to an embodiment of the present invention;

FIG. 3 is a flow chart showing a method of digital watermarking according to an embodiment of the present invention;

FIG. 4 illustrates an architecture of a digital watermarking system according to an embodiment of the present invention;

FIG. 5 shows a co-ordinate system used in the present disclosure; and

FIG. 6 shows an overview of the watermark underlay/overlay generation process and three application methods used in embodiments of the present invention.

### DETAILED DESCRIPTION

The present disclosure provides a deep learning model with three different text-independent, content-agnostic methods of embedding watermark into electronic document. A minimum crop resolution strategy is also proposed and integrated into the design of the model's architecture which enables watermark to be robust against image cropping. Additionally, text noise is also introduced so that the watermark is robust to text variations. Minimum crop resolution as used herein, refers to a crop size Hₘᵢₙ×Wₘᵢₙ selected such that a crop from a circularly padded watermark of at least Hₘᵢₙ×Wₘᵢₙ contains a sub-crop that corresponds to a phase-shifted instance of the base watermark, thereby enabling shift-invariant extraction.

The first method of watermarking document is the document underlay method. The proposed model generates a perceptually plain watermark image that is used as document background. With document editors like MS Word or MS Excel, a background image can be easily inserted. In MS Word (Version 2409 Build 16.0.18025.20214) 64-bit for instance, watermarked background image can be applied to a document through the ‘Watermark’ option under the ‘Design’ tab. This method can be applied with active watermarking to Leakage 1 to 7 given that the document allows background image to be inserted. For passive watermarking, this method is applicable for Leakage 1 to 3. Computer scripts and programs can be installed on Bob's office computer to scan through files to perform passive watermarking.

The second method is a screenshot & image overlay method. The watermark overlay generated by proposed model is applied onto image and therefore is applicable to Leakage 6 and 7 with active watermarking and Leakage 2, 4, and 6 for passive watermarking.

The third method of embedding watermark is a screen overlay method. As the watermark overlay is content-agnostic, a static overlay can be applied onto the screen regardless of its dynamic content. The application of screen overlay can be achieved with various application programming interface (API) like OpenGL and Win32. For active watermarking, this method can be applied on Leakage 4 to 7 regardless of the type of document (such as spreadsheet, email, etc). For passive watermarking, this method can be applied to Leakage 2 to 5, and 7.

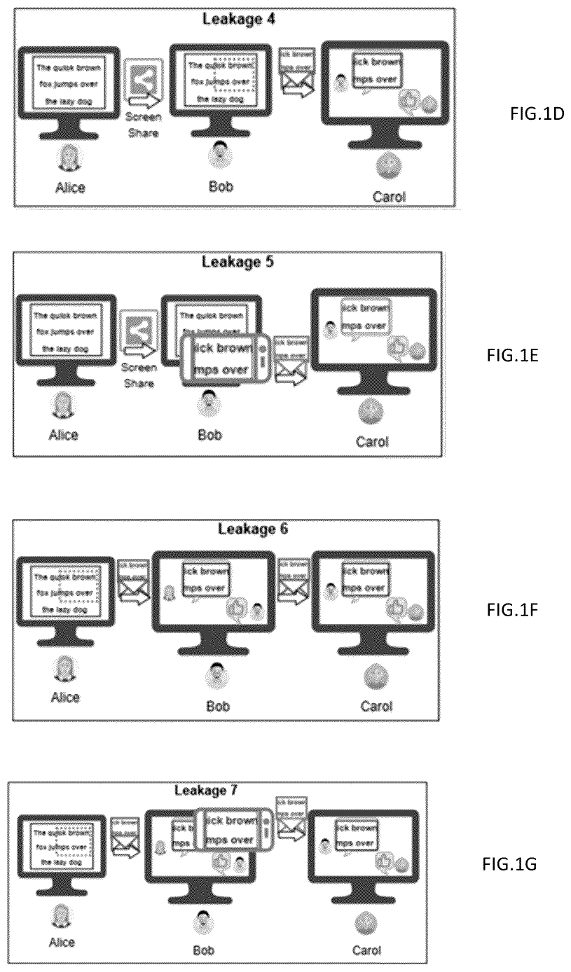

FIG. 2 is a block diagram showing a digital watermarking system according to an embodiment of the present invention. The digital watermarking system 100 is a computer system with memory that stores computer program modules which implement digital watermarking methods according to embodiments of the present invention.

The digital watermarking system 100 comprises a processor 110, a working memory 112, an input interface 114, an output interface 116, and program storage 120. The processor 110 may be implemented as one or more central processing unit (CPU) chips. The program storage 120 is a non-volatile storage device such as a hard disk drive which stores computer program modules. The computer program modules are loaded into the working memory 112 for execution by the processor 110. The input interface 114 is an interface which allows data to be received by the digital watermarking system 100, for example documents to which a digital watermark is to be added. The input interface 114 may be a wireless network interface such as a Wi-Fi or Bluetooth interface, alternatively it may be a wired interface. The output interface 116 is an interface which allows the digital watermarking system 100 to output results digitally watermarked documents.

The program storage 120 stores a watermark embedding module 122, a circular padding module 124, a noise module 126, and a watermark extraction module 128.

The circular padding module 124 is operable to perform a circular padding operation on an image patch by cycling the input image array back on the opposite border.

The computer program modules cause the processor 110 to execute various digital watermarking processing which is described in more detail below. The program storage 120 may be referred to in some contexts as computer readable storage media and/or non-transitory computer readable media. As depicted in FIG. 2, the computer program modules are distinct modules which perform respective functions implemented by the digital watermarking system 100. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the computer program modules is described herein, these may alternatively be implemented as one or more hardware modules (such as field-programmable gate array(s) or application-specific integrated circuit(s)) comprising circuitry which implements equivalent functionality to that implemented in software.

Although digital watermarking system 100 is described with reference to a computer, it should be appreciated that the digital watermarking system 100 may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the digital watermarking system 100 to provide the functionality of a number of servers that is not directly bound to the number of computers in the digital watermarking system 100. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

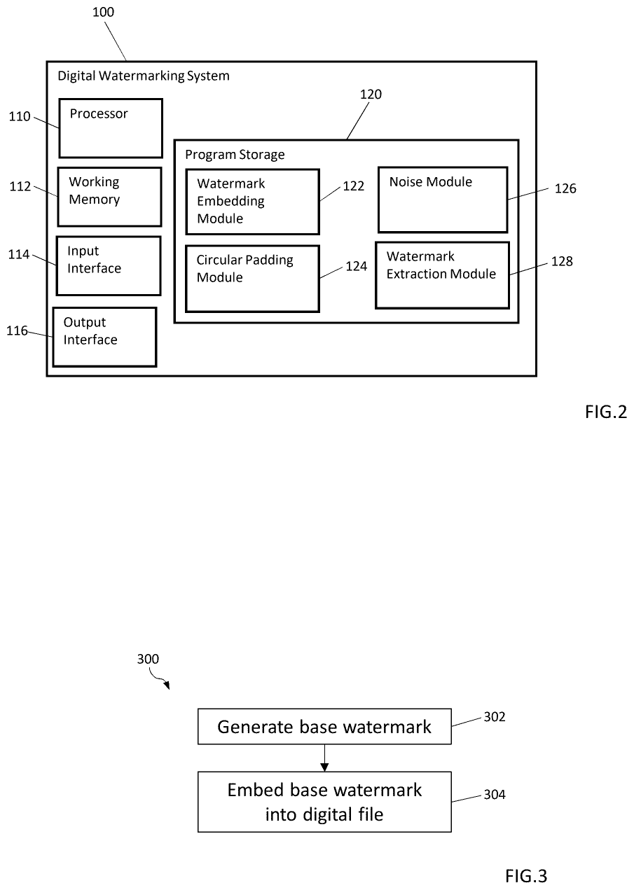

FIG. 3 is a flow chart showing a method of digital watermarking according to an embodiment of the present invention. The method 300 shown in FIG. 3 is carried out by the digital watermarking system 100 shown FIG. 2.

In step 302, the watermark embedding module 122 is executed by the processor 110 to generate a base watermark. The base watermark is generated from a watermark data set by embedding the watermark data set into image patches of the base watermark according to patch positional indices. A base watermark refers to a two-dimensional watermark image I_{wm} having dimensions Hₘᵢₙ×Wₘᵢₙ, partitioned into non-overlapping patches of size h×w, wherein a watermark data set is embedded into the patches according to patch positional indices

In step 304, the circular padding module 124 is executed by the processor to embed the base watermark into a digital file by circular padding.

Circular padding refers to periodic extension (wrap-around tiling) of an image in at least a horizontal direction and a vertical direction, such that pixel indices outside the image bounds are mapped back into the image bounds by a modulo operation, optionally followed by cropping to a target size.

As Leakage 2 to 7 are associated with cropped image of document, the watermark needs to be robust against cropping. Therefore, the minimum crop resolution strategy is proposed and incorporated into the model architecture for training. This will ensure that it is robust against image cropping up to the minimum crop resolution. The strategy is as follows:

For an image Iₘᵢₙ(x, y) with height and width of Hₘᵢₙ×Wₘᵢₙ where {x ∈ [symbol] |0≤x<Wₘᵢₙ} and {y ∈ [symbol] |0≤y<Hₘᵢₙ}, the minimum crop resolution is defined as Hₘᵢₙ×Wₘᵢₙ.

Consider repeating Iₘᵢₙ spatially (i.e., circular padding) to form an image I (x, y) with height and width of H×W where {x ∈ [symbol] |0x<W} and {y ∈ [symbol] |0<y<H}.

Then, an image I_{c}(x, y) of H_{c}×W_{c} cropped from I has the domain {x ∈ [symbol] |x_{c}≤x<(x_{c}+W_{c})} and {y ∈ [symbol] |y_{c}≤y<(y_{c}+H_{c})} where the top left of the crop is at (x_{c}, y_{c}). It is to be noted that 0≤x_{c}≤(W−W_{c}) and 0≤y_{c}≤(H−H_{c}).

If H_{c}>Hₘᵢₙ and W_{c}>Wₘᵢₙ, any I_{c} can be further cropped into I_{c}′(x, y) of Hₘᵢₙ×Wₘᵢₙ with the {x ∈ [symbol] |x′_{c}≤x<(x′_{c}+Wₘᵢₙ)} and {y ∈ [symbol] |y′_{c}≤y<(y′_{c}+Hₘᵢₙ)} where the top left of the second crop is at (x′_{c}, y′_{c}).

It is to be noted that x_{c}≤x′_{c}≤(x_{c}+W_{c}−Wₘᵢₙ) and y_{c}≤y′_{c}≤(y′_{c}+H_{c}−Hₘᵢₙ)

Then, any

$${I}_{c}^{′}$$

is just a phase shifted or circular shifted Iₘᵢₙ. With a shift-invariant function Fᵢₙᵥ(·),

$${F}_{inv} ( {I}_{c}^{′} ) = {F}_{inv} ( {I}_{min} ) ∀ {I}_{c}^{′} .$$

Assume that a watermark I of H×W is created based on this strategy by circular padding of a base watermark I_{wm} of H_{wm}×W_{wm}. If a shift-invariant watermark extracting module is capable of extracting watermark data accurately from I_{wm}, then it will also work on any other cropped images I_{c} of H_{c}×W_{c} since they can just be reduced to

$${I}_{c}^{′}$$

of Hₘᵢₙ×Wₘᵢₙ.

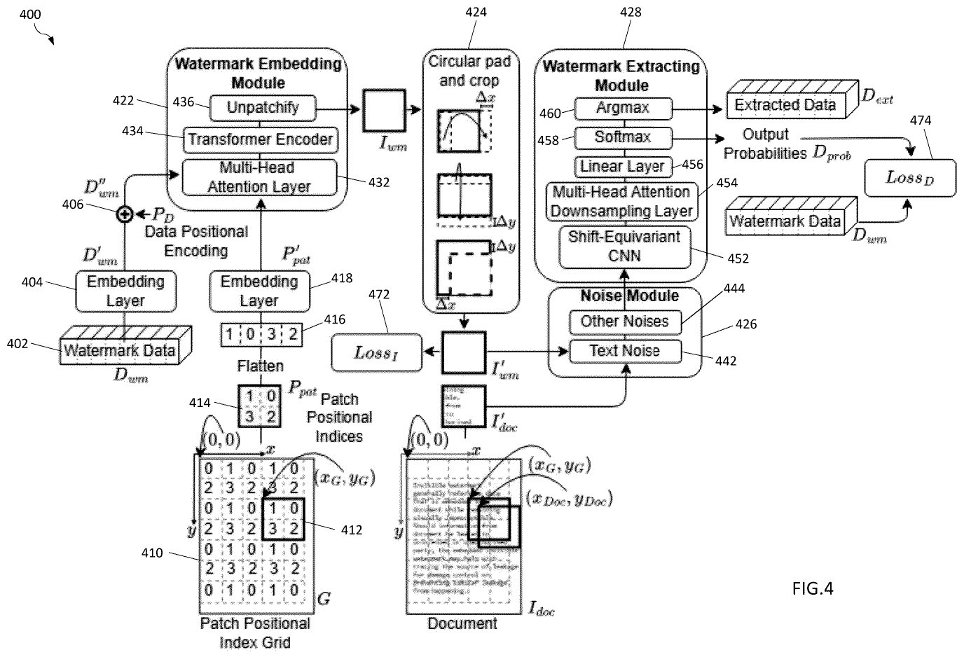

FIG. 4 illustrates an architecture of a digital watermarking system according to an embodiment of the present invention. The architecture 400 comprises a watermark embedding module 422, a circular pad and crop module 424, a noise module 426 and a watermark extracting module 428. Which correspond to the watermark embedding module 122, the circular pad and crop module 124, the noise module 126 and a watermark extracting module 128 stored in the program storage 120 of the digital watermarking system 100 shown in FIG. 2.

The watermark embedding module 422 comprises a multi-head attention layer 432, a transformer encoder 434 and an unpatchify module 436.

The watermark embedding module 422 takes embedded watermark data and embedded positional indices as inputs. As shown in FIG. 4, watermark data 402 is passed through an embedding layer 404 and summed 406 with positional data encoding.

Consider a watermark data tensor D_{wm} ∈ {0,1,2 . . . , 2^{N}^{_{B}}−1} ND where each element in D_{wm} is a base-ten representation of base-two N_{B} bits. D_{wm} goes through a learnable embedding layer and outputs D′_{wm} ∈ [symbol] where each element in D_{wm} is mapped to a one-dimensional tensor of length N_{emb}. A learnable positional encoding PD E [symbol] is then summed with D′_{wm} to form D″_{wm}.

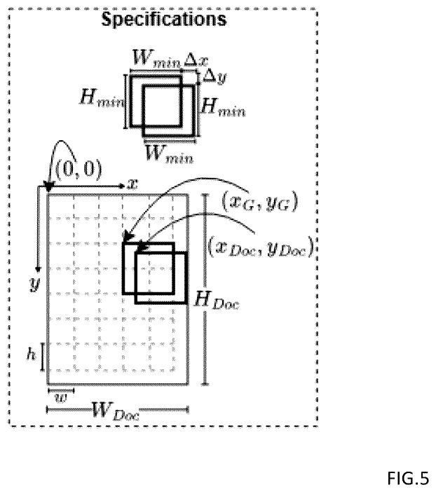

FIG. 5 shows a co-ordinate system used in the present disclosure. As shown in FIG. 5, (0,0) is the origin. Given an image of a document page I_{doc}(x, y) with height and width H_{doc}×W_{doc} where {x ∈ [symbol] |0≤x<W_{doc}} and {y ∈ [symbol] |0≤y<H_{doc}}, an image I′_{doc}(x, y) Of H_{doc}×W_{doc} is randomly cropped where {x ∈ [symbol] |x_{doc}≤x<(x_{doc}+Wₘᵢₙ}, {y ∈ [symbol] y_{doc}≤y<(y_{doc}+Hₘᵢₙ)}, and (x_{doc},y_{doc}) is the top left of crop. It is important to note that Hₘᵢₙ and Wₘᵢₙ must be divisible by h and w respectively where h×w is the height and width of an image patch. This means that I′_{doc} will contain (Hₘᵢₙ·Wₘᵢₙ)/(h·w) number of image patches.

Returning now to FIG. 4, A patch positional index grid G comprising patch positional indices is also constructed where an image 410 of H_{doc}×W_{doc} is segregated into image patches of h×w and there are [H_{doc}/h] number of vertical patches and [W_{doc}/w] number of horizontal patches. Each patch will be labelled by its top left coordinate of (x, y)=(n_{w}w, nₕh) where

$${n}_{w} ∈ \{ 0 , 1 , 2 … [ \frac{{W}_{doc}}{w} ] - 1 \} and {n}_{h} ∈ \{ 0 , 1 , 2 … [ \frac{{H}_{doc}}{h} ] - 1 \} ,$$

and has a corresponding patch positional index:

$$index = ( {n}_{w} mod \frac{{W}_{min}}{w} ) + ( \frac{{W}_{min}}{w} {n}_{h} mod \frac{{H}_{min}}{h} ) \qquad ( 1 )$$

The purpose of G is to map the patches in I_{doc} to its corresponding patch positional indices. For a mapping to be done, (x_{doc},y_{doc}) must fall on valid coordinates which satisfy (x_{doc}, y_{doc})=(n_{w}w, nₕh) is not a valid coordinate, the mapping will be done on a shifted crop with top left coordinate (x_{G}, y_{G})=(x_{doc}+Δx, y_{doc}+Δy) and the displacements Δx, Δy will be compensated in a later part of architecture.

The shifted crop 412 with (x_{G}, y_{G}) as its top left coordinate will be converted to its patch positional indices Pₚₐₜ ∈ ∈ [symbol] 414 with the help G. It will then be flattened to a [symbol] tensor 416 where Nₚₐₜ=(Hₘᵢₙ·Wₘᵢₙ)/(h·w). After which, it goes through an embedding layer 418 where each element is mapped to a one-dimensional tensor of length N_{emb} to form P′ₚₐₜ ∈

[symbol]

P′ₚₐₜ then samples from D″_{wm} through the multi-head attention layer 432 (MHAL) parameterized by the number of heads k_{emb}.

$$AL ( Q , K , V ) = softmax ( {QK}^{T} / \sqrt{{N}_{head}} ) V \qquad ( 2 )$$

$$MHAL ( Q , K , V ) = concat ( {head}_{1} , {head}_{2} , {head}_{3} , … {head}_{{k}_{emb}} ) {W}^{0} \qquad ( 3 )$$

Where

$$\text{?}$$

are learnable, a, and N_{head}=N_{emb}/k_{emb}.

The output from MHAL is a [symbol] tensor which will go through L_{emb} layers of the transformer encoder 434 followed by an unpatchify transformation by the unpatchify module 436. The transformer maps the tensor from [symbol] into I_{wm}(x, y) of Hₘᵢₙ×Wₘᵢₙ Where {x ∈ [symbol] |0≤x<Wₘᵢₙ} and {y ∈ [symbol] |0≤y<Hₘᵢₙ}.

The circular padding and crop module 424 then carries out a circular padding of Δx along the horizontal axis and Δy along the vertical axis is then performed followed by Hₘᵢₙ×Wₘᵢₙ cropping at (Δx, Δy) to output I′_{wm}(x, y) where {x ∈ [symbol] |Δx≤x<Δx+Wₘᵢₙ} and {y ∈ [symbol] |Δy≤y<Δy+Hₘᵢₙ}. This is to compensate for the adjustment made during the patch positional index mapping.

I′_{wm} and I′_{doc} will then enter the noise module 426 which outputs I_{noisy}. The noise module 426 adds text noise 442 and other noises 444. There are two types of text noise 442 proposed namely underlay text noise and overlay text noise, where both will be used in training. Here, “underlay text noise” refers to compositing the watermark and a document image by replacing background pixels of the document image with corresponding pixels from the watermark and “overlay text noise” refers to compositing the watermark and a document image by alpha blending the watermark and the document image. Given that p ∈ [0,1] is randomly generated in each training iteration and P_{under} ∈ [0, 1] is a preset constant, underlay noise is used if p<p_{under}; otherwise, overlay noise is used.

Underlay text noise simulates watermark underlay used in Method 1. All background pixels (e.g., white pixels) in I′_{doc} are replaced with the pixels in I′_{wm} at their corresponding pixel locations as follows:

$${I}_{noisy} ( x , y ) = \{ \begin{matrix}{I}_{wm}^{′} ( x , y ) & if {I}_{doc}^{′} ( x , y ) = 255 \\ {I}_{doc}^{′} ( x , y ) & otherwise\end{matrix} \qquad ( 4 )$$

Overlay text noise is used to simulate watermark overlay (for Method 2 and 3). Noting that {α ∈ [symbol] |0≤α≤1}. It is done through an alpha blending as follows:

$${I}_{src} = \frac{{I}_{wm}^{′} - 255 ( 1 - α )}{α} \qquad ( 5 )$$

$${I}_{noisy} = αmax ( 0 , {I}_{src}^{′} ) + ( 1 - α ) {I}_{doc}^{′} \qquad ( 6 )$$

The reason an intermediate I_{src} through Equation 5 and alpha blending is performed on it instead of I′_{wm} is due to a needing to take on a small value, in order to achieve visual imperceptibility. For the instance where a=0.02 and the pixel value is between 0 and 255, ΔI_{src}=50⇒ΔI_{noisy}=1. Therefore, the image used for alpha blending in Equation 6 needs to take on a large range of values. However, I′_{wm} cannot take on such a large range as it has to be as close to white as possible in order to achieve visual imperceptibility for Method 1.

By creating an intermediate I_{src}, I′_{wm} can be optimized to the pixel values of white which serve in the interest of Method 1. It will result in 0≤α max (0, I′_{src})≤5 0 for the case of α=0.02 which is also favorable to Method 2 and 3. Depending on the needs, other noises like scaling, simulated H.264 codec, simulated JPEG compression, can also be added after the text noise.

From the minimum crop resolution strategy, the watermark extracting module 428 must be shift-invariant. Therefore, a shift-equivariant CNN 452 is followed by a proposed multi-head attention down sampling layer (MHADL) 454 to make the watermark extraction shift-invariant. The CNN 452 outputs a feature map M ∈ [symbol] where N_{H}×N_{W} is the height and width of feature map and Nₑₓₜ is the number of output channels. The feature map is then flattened to [symbol] and enters MHADL 454 as follows:

$$MHADL ( Q , K , V ) = concat ( {head}_{1} , {head}_{2} , {head}_{3} , … {head}_{{k}_{ext}} ) {Z}^{0} \qquad ( 7 )$$

### Where

$${head}_{i} = AL ( {Z}_{i}^{Q} , {MZ}_{i}^{K} , {MZ}_{i}^{V} ) , {Z}_{i}^{K} , \\ {Z}_{i}^{V} , ∈ \text{?} , and {Z}_{i}^{V} , ∈ \text{?}$$

are learnable, where N_{head}=Nₑₓₜ/kₑₓₜ.

Recalling that N_{D} is the length of input watermark data and N_{B} is the number of base-two bits, a linear layer 456 is then applied onto the output of MHADL which projects a [symbol] tensor to [symbol] . Following which, a softmax 458 is applied to produce the probabilities D_{prob} ∈ [symbol] . Finally, the data extracted from the watermarked image Dₑₓₜ is obtained by applying an argmax 460 over D_{prob}.

There are two loss functions involved in the training process. Loss_{I} 472 is the loss for encouraging visual imperceptibility in the overlay and underlay with input I′_{wm} and a target of plain image (e.g. white image). L1 and MSE losses are possible candidates for Loss₁. Loss_{D} 474 is a cross-entropy loss used to improve data predictions with input D_{prob} and target D_{wm}. The training process minimises the total loss as

$${Loss}_{ot} = {β}_{I} {Loss}_{I} + {β}_{D} {Loss}_{D} \qquad ( 8 )$$

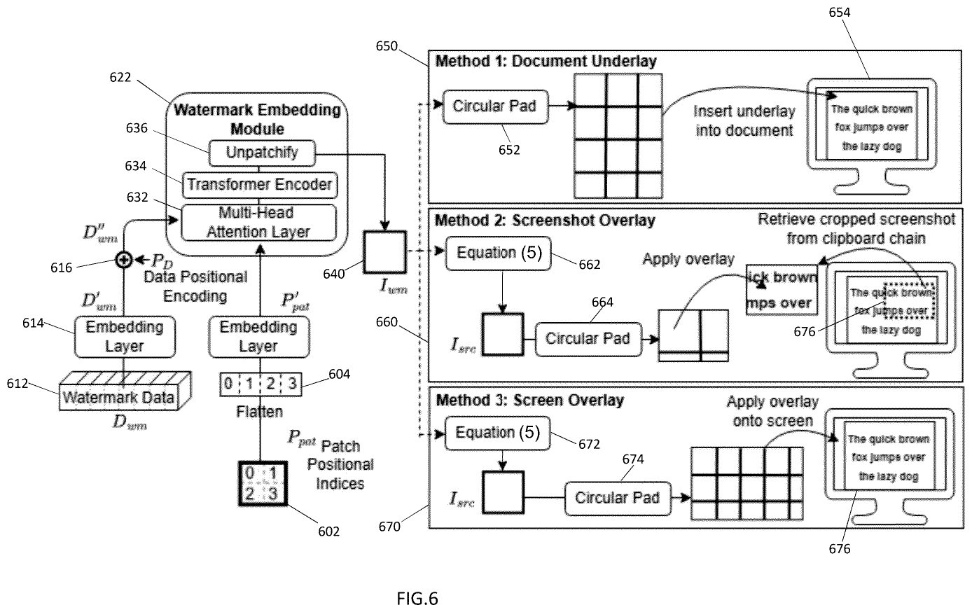

FIG. 6 shows an overview of the watermark underlay/overlay generation process and three application methods used in embodiments of the present invention.

Watermark data 612 is embedded by an embedding layer 614 and data positional encoding 616 is carried out.

Patch position indices 602, Pₚₐₜ are generated from equation 1 where n_{w} ∈ 0,1,2, . . . . Hₘᵢₙ/w−1} and nₕ ∈ {0,1,2, . . . Hₘᵢₙ/h−1} and flattened into [0,1,2, . . . Nₚₐₜ−1] 604 recalling that Nₚₐₜ is the number of patches in an Hₘᵢₙ×Wₘᵢₙ image. An embedding layer 606 is applied to obtain P′ₚₐₜ. Watermark data 612 is embedded by an embedding layer 614 and data positional encoding 616 is carried out to obtain D″_{wm}. With P′ₚₐₜ and D″_{wm}, a watermark image I_{wm} of Hₘᵢₙ×Wₘᵢₙ is generated by the watermark embedding module 622 which includes a multi-head attention layer 632, a transformer encoder 634 and an unpatchify module 636. It is to be noted that I_{wm} 640 generated from just one single model, is capable of being applied in three different ways.

If Method 1 650 is adopted, I_{wm} will first be circular padded 652 to the same size as the document. It will then be inserted into a document 654 like Microsoft Word or Excel. In MS Word for instance, watermarked background image can be applied to a document through the ‘Watermark’ option under the ‘Design’ tab. For MS Excel, the watermarked image can be inserted through ‘Background’ in the ‘Page Layout’ tab.

For the application of Method 2 660 or Method 3 670, Equation 5 662 672 is first applied on I_{wm} to produce I_{src}. It will then be circular padded 664 674 to the same size as a screenshot 666 for Method 2 or the size of screen 676 for Method 3. After which, it will be used in alpha blending with the screenshot or screen. Pertaining to Method 2, when a screenshot is made on Windows operating system (OS), it will be stored in clipboard chain. This can be retrieved in various ways like pywin32 module in Python. Alpha blending can then be done on the screenshot and released back to the clipboard chain. For Method 3, I_{wm} can be alpha blended with the screen through WinAPIs and OpenGL library in Windows OS.

The present disclosure provides three methods of watermarking with various commercial applications like copyright protection and source tracing for document leakage. A document creator may wish to watermark the creation to deter unauthorized distribution. In such case, the creator can utilize Method 1 to add a receiver-specific watermark underlay to the document. If any receiver were to distribute the document without authorization, the distribution source can be traced from the watermark.

In corporate setting, all three methods can be used independently or concurrently for watermarking in various leakage scenarios. For example, Alice arranges an online meeting and wishes to watermark any content that she will be sharing over the screen. Alice can apply Method 2 on her screen and if a meeting participant took a screenshot and distributes it without authorization, the watermark in the screenshot can trace it back to the meeting. Correspondingly, the organization can also impose Method 3 on all corporate devices such that any screenshot taken on such device will contain information of its user.

Whilst the foregoing description has described exemplary embodiments, it will be understood by those skilled in the art that many variations of the embodiments can be made within the scope and spirit of the present invention.

1. A method of digitally watermarking a digital file, the method comprising:
generating a base watermark comprising a two-dimensional pixel array partitioned into image patches from a watermark data set by embedding the watermark data set into the image patches of the base watermark according to patch positional indices; and
embedding the base watermark into the digital file by circular padding.

2. The method according to claim 1, wherein the digital file is a screenshot image and embedding the base watermark into the digital file by circular padding comprises applying the base watermark as an image overlay.

3. The method according to claim 1, wherein the digital file is a screen display and embedding the base watermark into the digital file by circular padding comprises applying the base watermark as an image overlay.

4. The method according to claim 1, wherein the digital file is an electronic document and embedding the base watermark into the digital file by circular padding comprises applying the base watermark as a document underlay.

5. The method according to claim 1, further comprising applying text noise to the base watermark.

6. The method according to claim 1, wherein a size of the base watermark is selected to provide a minimum crop resolution.

7. The method according to claim 1, wherein embedding the watermark data set into image patches of the base watermark according to patch positional indices comprises applying a multi-head attention layer.

8. The method according to claim 1, wherein embedding the base watermark into the digital file by circular padding comprising using patch positional indices.

9. The method according to claim 1, wherein embedding the base watermark into the digital file by circular padding comprises using circular padding and cropping.

10. A non-transitory computer readable medium storing processor executable instructions which when executed on a processor cause the processor to carry out a method according to claim 1.

11. A digital watermarking system comprising: a processor and a data storage device storing computer program instructions operable to cause the processor to:
generate a base watermark comprising a two-dimensional pixel array partitioned into image patches from a watermark data set by embedding the watermark data set into the image patches of the base watermark according to patch positional indices; and
embed the base watermark into the digital file by circular padding.

12. The system according to claim 11, wherein the digital file is a screenshot image and the data storage device further stores computer program instructions operable to cause the processor to embed the base watermark into the digital file by circular padding by applying the base watermark as an image overlay.

13. The system according to claim 11, wherein the digital file is a screen display and the data storage device further stores computer program instructions operable to cause the processor to embed the base watermark into the digital file by circular padding by applying the base watermark as an image overlay.

14. The system according to claim 11, wherein the digital file is an electronic document and the data storage device further stores computer program instructions operable to cause the processor to embed the base watermark into the digital file by circular padding by applying the base watermark as a document underlay.

15. The system according to claim 11, wherein the data storage device further stores computer program instructions operable to cause the processor to apply text noise to the base watermark.

16. The system according to claim 11, wherein a size of the base watermark is selected to provide a minimum crop resolution.

17. The system according to claim 11, wherein the data storage device further stores computer program instructions operable to cause the processor to embed the watermark data set into image patches of the base watermark according to patch positional indices by applying a multi-head attention layer.

18. The system according to claim 11, wherein the data storage device further stores computer program instructions operable to cause the processor to embed the base watermark into the digital file by circular padding using patch positional indices.

19. The system according to claim 11, wherein the data storage device further stores computer program instructions operable to cause the processor to embed the base watermark into the digital file by circular padding using circular padding and cropping.

20. The system according to claim 11, wherein the data storage device further stores computer program instructions operable to cause the processor to extract a digital watermark from a digital file.
